(19) United States
(12) Patent Application Publication
(10) Pub. No.: US 2022/0192798 A1
(43) Pub. Date: Jun. 23, 2022

(54) DENTAL ABUTMENT AND ABUTTING SYSTEM

(71) Applicants: MIKAMBEH LTD., Hod Hasharon (IL); SFM LTD., Hod Hasharon (IL)

(72) Inventor: Uzi BERGER, Hod Hasharon (IL)

(21) Appl. No.: 17/602,748

(22) PCT Filed: Mar. 31, 2020
(86) PCT No.: PCT/IL2020/050388

§ 371 Date: Oct. 9, 2021

(30) Foreign Application Priority Data
Apr. 14, 2019 (IL) 266021

(51) Int. Cl. A61C 8/00

(52) U.S. Cl. CPC A61C 8/0065; A61C 8/006; A61C 8/0068; A61C 8/0057

(57) ABSTRACT

A dental abutment comprising a cylindrical abutment body and a tubular reconstruction element support; the abutment body is couplable to a dental implant and comprises a flat support end, the reconstruction element support has a proximal anchoring head portion configured with at least one slot, and a distal seat end bearing flush against the flat support end of the abutment body, said reconstruction element support is further configured with an axially extending through-going head bore, whereby the reconstruction element support is coupled to the abutment body by a manipulating fastener extending through the bore, and wherein axial fastening the fastener entails radial expansion of the anchoring head.

### TECHNOLOGICAL FIELD

The present disclosure is generally concerned with dental prosthetics and more particularly with an adjustable abutment system, an abutment therefor, and a method for fixing a dental prosthesis using such an abutment.

### BACKGROUND ART

References considered to be relevant as background to the presently disclosed subject matter are listed below:

U.S. Pat. No. 9,668,833

KR101768410

U.S. Pat. No. 6,227,860

U.S. Pat. No. 9,603,679

WO16139671

Acknowledgement of the above references herein is not to be inferred as meaning that these are in any way relevant to the patentability of the presently disclosed subject matter.

### BACKGROUND

U.S. Pat. No. 9,668,833 discloses an abutment, comprising: a ceramic part; and a metal adapter removably attachable to the ceramic part, wherein the metal adapter has a conical connection interface adapted to attach to a dental implant, wherein the metal adapter comprises at least one flexible arm with a protrusion adapted to press against a side wall or snap into any corresponding recess of the ceramic part to secure the metal adapter to the ceramic part in the coronal-apical direction, wherein the metal adapter comprises at least one convex surface adapted to abut against at least one corresponding concave surface of the ceramic part to prevent rotation between the ceramic part and the metal adapter, wherein the metal adapter at its coronal end has a central protruding portion which is adapted to be received in a central apical recess of the ceramic part, and wherein said central protruding portion accommodates said at least one convex surface and said at least one flexible arm is housed within said central protruding portion

KR101768410 discloses a detachable locking link capable of compensating an upper prosthesis which, when a compensation of an upper prosthesis is required, is allowed to compensate the upper prosthesis on the basis of a structural characteristic which is easily detachably attached from the upper prosthesis, and is easily used and disassembled and assembled again during in use, and a method for assembling an upper prosthesis using the same. The detachable locking link comprises: a coupling unit which is interposed by an upper prosthesis; an implant unit which is interposed by an implant; and an extension blade unit which is extended to the side direction at a border of the implant unit and the coupling unit. Accordingly, the locking link induces an implant and the upper prosthesis to be mutually coupled with each other. The coupling unit is coupled by being forcibly inserted into the inside of an insertion hole of the upper prosthesis, wherein an upper end divided as two or more places is frictionally inserted and interposed with the insertion hole of the upper prosthesis.

U.S. Pat. No. 6,227,860 discloses a dental implant that includes a cylindrical body which can be positively secured against micromotion within a bore in a jawbone by a spindle-shaped expansion mechanism and further secured against the contamination by microorganism through a gap in an internal channel of tubular portion by a compressive contact mechanism

U.S. Pat. No. 9,603,679 discloses a root canal abutment devices and methods which facilitate the adjustment or removal of an oral appliance, e.g., a crown or bridge, from a reconfigurable abutment assembly are described. The adjustable abutment assembly may be secured within a pulp chamber of a pre-existing tooth. The abutment assembly has a projecting abutment portion with one or more shape memory alloy sleeves or plates or elements extending along the abutment. Each of the sleeves has a length with at least one curved or arcuate portion. Energy may be applied to the elements such that the arcuate portion flattens to allow for the oral appliance to be placed thereupon while removal of the energy allows the elements to reconfigure into its curved configuration thereby locking the oral appliance to the abutment. Removal of the oral appliance may be effected by reapplication of energy to the elements.

WO16139671 discloses a dental abutment comprising first and second ends, each configured for being secured to an element of a dental reconstruction system, is provided. The dental abutment comprises an abutment housing defining a first axis and comprising the first end, and a positioning element received therewithin, defining a second axis and comprising the second end. The dental abutment is configured to selectively permit free continuous three-dimensional rotation of the positioning element through a range of orientations within the abutment housing, and arrest the positioning element within the abutment housing at any of the orientations. Further provided is an integrated dental implant comprising an implant portion with an abutment portion as provided.

### GENERAL DESCRIPTION

According to a first aspect of the present disclosure there is provided a dental abutment configured for securing a dental reconstruction element to a dental implant, said dental implant configured for adjustably mounting a dental reconstruction element over a dental implant.

Herein after in the specification and claims, the term “dental reconstruction element” is used in its broad sense and denotes any form, any full or partial, of a support bar, mini support bar, full/partial denture, full or partial dental bridge, dental crown, or any other similar dental element constituting or supporting any type of dental prosthesis, either in full or partial.

Other aspects of the disclosure are directed to a dental reconstruction set and system configured for securing a dental reconstruction element to a dental implant via a dental abutment, and a method for performing same.

According to a particular aspect of the disclosure, the dental abutment provides adjustable mounting of a dental reconstruction element, at least about a longitudinal axis of the abutment.

A first aspect of the disclosure is concerned with a dental abutment for screw coupling to a dental implant, said abutment comprises a reconstruction element support configured for radial expansion anchorage within a bore of a dental reconstruction element.

According to an aspect of the disclosure there is a dental abutment comprising a cylindrical abutment body and a tubular reconstruction element support; the abutment body is couplable to a dental implant and comprises a flat support end, the reconstruction element support has a proximal anchoring head portion configured with at least one slot, and a distal seat end bearing flush against the flat support end of the abutment body, said reconstruction element support is further configured with an axially extending through-going head bore, whereby the reconstruction element support is coupled to the abutment body by a manipulating fastener extending through the bore, and wherein axial fastening the fastener entails radial expansion of the anchoring head.

The arrangement is such that radial expansion of the anchoring head portion results facilitates arresting against inside walls within a bore of a dental reconstruction element.

The arrangement is such that when at least the anchoring head portion of the dental abutment is received within a bore of a dental reconstruction element, axial force applied to the reconstruction element support entailing radially outward expansion of the anchoring head against an inside wall surface of said bore, thus anchoring the dental abutment within the dental reconstruction element so as to set at least longitudinal axial positioning of the dental reconstruction element over the dental abutment,

The dental abutment and system disclosed herein is suitable for bearing and overcoming tolerances which may occur owing to measuring deviations, manufacturing deviations, etc. Such tolerances can extend axially, i.e. along the longitudinal axes of the dental system, or in planes intersecting said longitudinal axes.

It is noted that the disclosed arrangement facilitates for compensating positioning tolerances and inaccuracies that may reside between axes of the dental implant and the dental reconstruction element, where such tolerances can reside about a longitudinal axis (‘Z axis’) or about axes intersecting said longitudinal axis (‘X axis’ and ‘Y axis’), giving rise to yaw, pitch and roll compensation.

The at least one slot of the reconstruction element support extends form the proximal towards the seat end, wherein the reconstruction element support arrests within the dental reconstruction element like a so-called ‘slotted wall anchor’.

According to a first embodiment of the disclosure, the abutment body is tubular and is configured with a through-going abutment bore extending between an implant end and the flat support end, said abutment bore configured with an inside fastener shoulder, whereby the abutment body is couplable to a dental implant by a implant fastener extending through the abutment body.

According to this embodiment, the manipulating fastener is screw coupled within an internal threading configured within the implant fastener.

According to a second embodiment of the disclosure, the abutment body is a tubular body configured at an implant end thereof with an integral threaded fastener couplable within a threaded bore of a dental implant, said abutment body is further configured at an opposite end thereof with a wrench engaging portion. According to this embodiment, the manipulating fastener is screw coupled within an internal threading configured within the abutment body.

According to yet another embodiment of the present disclosure, the abutment body is configured with a first axis and a second axis; with a threaded bore extending along said first axis for screw coupling the tubular reconstruction element support, and wherein the abutment body is couplable to a dental implant along said second axis.

According to a particular configuration said first axis and said second axis intersect each other about an imaginary plane.

According to this embodiment the abutment body is configured with an implant end configured for bearing over an internal head portion of a dental implant, said implant end is configured as an external polygonal boss couplable at discrete angular increments within a polygonal socket of the dental implant, said polygonal boss coextends along said second axis.

According to a particular example the external polygonal boss of the abutment body is a 12 faced polygon and the polygonal socket of the dental implant is a 6 faced polygon, imparting the abutment body axial angular increments of 30° over the dental implant. However, other combinations of polygonal boss and polygonal socket can be adopted, e.g. 8 faced polygonal boss with an 8 faced polygonal socket, 8 faced polygonal boss with a 16 faced polygonal socket, 6 faced polygonal boss with a 6 faced polygonal socket, etc.

The angle between the first axis and the second axis is in the range of about 3° to 8°, and typically about 5°.

According to another aspect of the present disclosure there is a dental reconstruction element comprising a thorough going bore configured for snug receiving at least a reconstruction element support of a dental abutment, said thorough going bore further configured for bearing radial engaging forces applied thereto by an anchoring head of the reconstruction element support which in turn is articulated to the dental abutment.

According to yet an aspect of the present disclosure there is a dental reconstruction set comprising one or more of each of a dental reconstruction element, a dental implant, and a dental abutment comprising a dental abutment comprising a cylindrical abutment body and a tubular reconstruction element support; the abutment body is couplable to a dental implant and comprises a flat support end, the reconstruction element support has a proximal anchoring head portion configured with at least one slot, and a distal seat end bearing flush against the flat support end of the abutment body, said reconstruction element support is further configured with an axially extending through-going head bore, whereby the reconstruction element support is coupled to the abutment body by a manipulating fastener extending through the bore, and wherein axial fastening the fastener entails radial expansion of the anchoring head.

It is noted that any polygonal boss or polygonal socket referred to herein can be used with any suitable shaped tool, suitable for internal and corresponding external driving (i.e. screw manipulating) of the dental components, such as, Torx, Allen, fluted, slotted, etc.

Any one or more of the following features, designs and configurations can be applied to the dental abutment subject of the present disclosure, and other aspects of the disclosure, independently or in combinations thereof:
the abutment body can be coupled to a dental implant directly or indirectly, with an intermediate adapter seat member disposed therebetween, wherein the adapter seat member has a body with a thorough going bore extending between abutment end mimicking an external head portion of a dental implant, and an implant end configured for bearing over an internal head portion of a dental implant;
the adapter seat member can be integral with or integrated with the abutment body;
a dental implant end of the abutment body is configured for direct bearing over an external cylindrical head portion of a dental implant, or over an adapter seat member extending between the abutment body and the dental implant;
a dental implant end of the abutment body can be cylindrical and configured for at least partially insertion into an open end of a dental implant;
a portion of the abutment body can be configured at an external face thereof with a wrench gripping arrangement. According to one configuration, the wrench gripping arrangement is a polygonal shape. According to another configuration, the wrench gripping arrangement is a one or more recesses or depressions over an external surface of the abutment body;
the at least one slot of the of the reconstruction element support can extend axially, parallel to the axis of the longitudinal head bore, imparting it a symmetrically segmented shape;
the at least one slot of the of the reconstruction element support can extend helically;
the anchoring head of the reconstruction element support can be configured with symmetrically disposed at least two slots;
the reconstruction element support can be made of the same material as that of the abutment body, or of a different material, with different mechanical properties;
the anchoring head portion of the reconstruction element support can be configured with a cylindrical external cross-section;
the anchoring head portion of the reconstruction element support can be configured with an externally spherical or have a spherical portion, or rounded portion cross-section;
at least the anchoring head portion of the reconstruction element support can be configured with surfacing for improved engagement with inside wall surface of the bore of the dental reconstruction element. Such surfacing can be, for example, serrations, knurling, axial/annular ridges, axial/annular grooves, roughened surfacing, etc.;
the wrench engaging portion of the abutment body can be a polygonal socket or a polygonal external surface;
a distal end of the axially extending through-going head bore of the reconstruction element support can be configured with an inwardly tapering section, configured for engagement with a radial annular projection of the manipulating fastener;
a distal end of the axially extending through-going head bore of the reconstruction element support can be configured with an inwardly tapering section, configured for engagement with a radial annular projection of the manipulating fastener;
the radial annular projection of the manipulating fastener can be cylindrical;
the radial annular projection of the manipulating fastener can be tapering in direction of tapering section of the reconstruction element support;
a manipulating disc can be disposed between the tapering section of the reconstruction element support and the manipulating fastener, wherein said manipulating disc is configured with a tapering external surface corresponding with the tapering section of the reconstruction element support, and wherein the manipulating fastener applies substantially axial force to the manipulating disc which in turn gives rise to outwardly directed radial forces aimed applied to an inside face of the reconstruction element support;
at an assembled position, the tubular reconstruction element support extends coaxially with abutment body;
at an assembled position, the manipulating fastener extends coaxially with the tubular reconstruction element support;
a distal portion of the abutment body can be configured with a tapering shoulder, which upon coupling to a dental implant can bear over a correspondingly tapering internal tapering portion of the dental implant;
the bore of a dental reconstruction element can be configured a distal end thereof with an annular shoulder, which at an assembled position is configured for bearing over a cylindrical portion of the abutment body;
a resilient sealing member can be disposed between a distal end of the bore of the dental reconstruction element and an external surface of the abutment body. Such a resilient sealing member is suitable to eliminate or substantially reduce saliva and food from entering into a space extending between the bore of the dental reconstruction element and the external surface of the abutment body
it is appreciated that any fastener can be used for articulating the dental reconstruction element to the abutment body and in turn for articulating the abutment body to a dental implant. Particularly, fasteners can be configured with internal or external polygonal heads/sockets;
the abutment body can be mounted over any type of platform, e.g. a dental implant configured with an external polygonal head, a dental implant configured with an internal polygonal socket, a dental implant configured with a conical connection, etc.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a top perspective view of a dental set comprising a dental abutment according to a first embodiment of the present disclosure;

FIG. 1B is an exploded view of FIG. 1A;

FIG. 1C is a longitudinal section taken along line I-I in FIG. 1A;

FIG. 1D is an exploded view of FIG. 1C;

FIG. 1E is a top perspective view of a dental abutment used in the dental set of FIG. 1A;

FIG. 1F is an exploded view of FIG. 1E;

FIG. 1G is a longitudinal section of FIG. 1E;

FIGS. 1H to 1K are directed to a modification of the dental set illustrated in FIGS. 1A to 1G, wherein:

FIG. 1H is a top perspective view of the dental set;

FIG. 1I is an exploded view of FIG. 1H;

FIG. 1J is a longitudinal section of FIG. 1H;

FIG. 1K is an exploded view of FIG. 1J;

FIG. 2A is a top perspective view of a dental set comprising a dental abutment according to a second embodiment of the present disclosure;

FIG. 2B is an exploded view of FIG. 2A;

FIG. 2C is a longitudinal section taken along line II-II in FIG. 2A;

FIG. 2D is an exploded view of FIG. 2C;

FIG. 2E is a top perspective view of a dental abutment used in the dental set of FIG. 3A;

FIG. 2F is an exploded view of FIG. 2E;

FIG. 2G is a longitudinal section of FIG. 2E;

FIG. 3A is a top perspective view of a dental set comprising a dental abutment according to a modification of the second embodiment of the present disclosure;

FIG. 3B is an exploded view of FIG. 3A;

FIG. 3C is a longitudinal section taken along line III-III in FIG. 3A;

FIG. 3D is an exploded view of FIG. 3C;

FIG. 3E is a top perspective view of a dental abutment used in the dental set of FIG. 3A;

FIG. 3F is an exploded view of FIG. 3E;

FIG. 3G is a longitudinal section of FIG. 3E;

FIGS. 3H and 3I illustrate examples of the dental set of FIG. 3A, demonstrating tolerance rectifying;

FIG. 4A is a top perspective view of a dental set comprising a dental abutment according to a third embodiment of the present disclosure;

FIG. 4B is the same as FIG. 4A, however with a dental reconstruction element sectioned;

FIG. 4C is a longitudinal section taken along line IV-IV in FIG. 4A;

FIG. 4D is an enlargement of the portion marked IV in FIG. 4C;

FIG. 4E is a longitudinal section taken along line V-V in FIG. 4B;

FIG. 4F is a an exploded view of FIG. 4E;

FIG. 4G is a an exploded view of FIG. 4B;

FIG. 4H is an enlarged planar sectioned view of the abutment used in the example illustrated in FIG. 4E;

FIG. 4I is a top perspective sectioned view of the abutment of FIG. 4H;

FIG. 4J illustrates the abutment of FIG. 4I with threaded fasteners articulated thereto;

FIG. 4K is a top perspective view of a dental abutment used in the dental set of FIG. 4A;

FIG. 4L is an exploded view of FIG. 4K;

FIG. 4M is a longitudinal section of FIG. 4K;

FIG. 5A is a top perspective view of a dental reconstruction set comprising support bar mounted over an array of abutments according to examples of the present disclosure; and

FIG. 5B is a planar view of FIG. 5A.

### DETAILED DESCRIPTION OF EMBODIMENTS

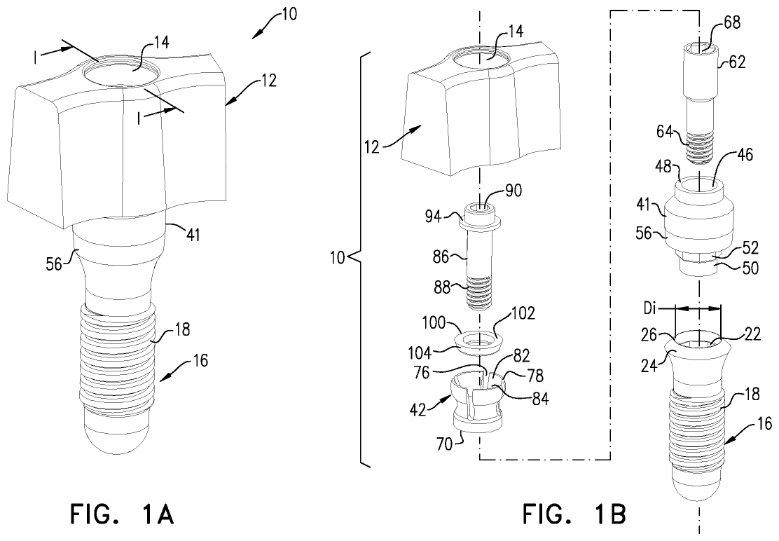

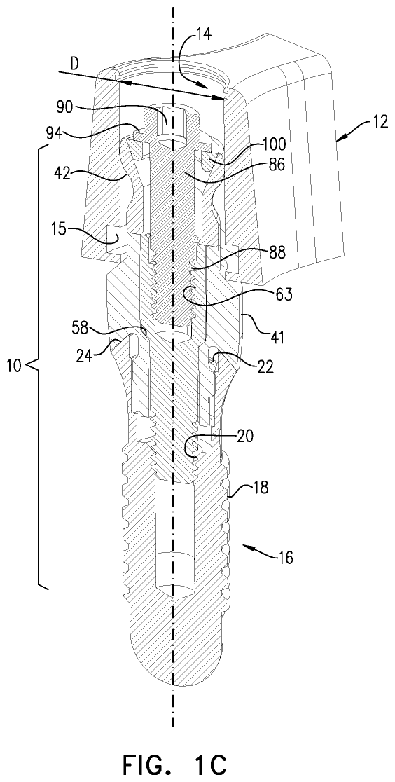

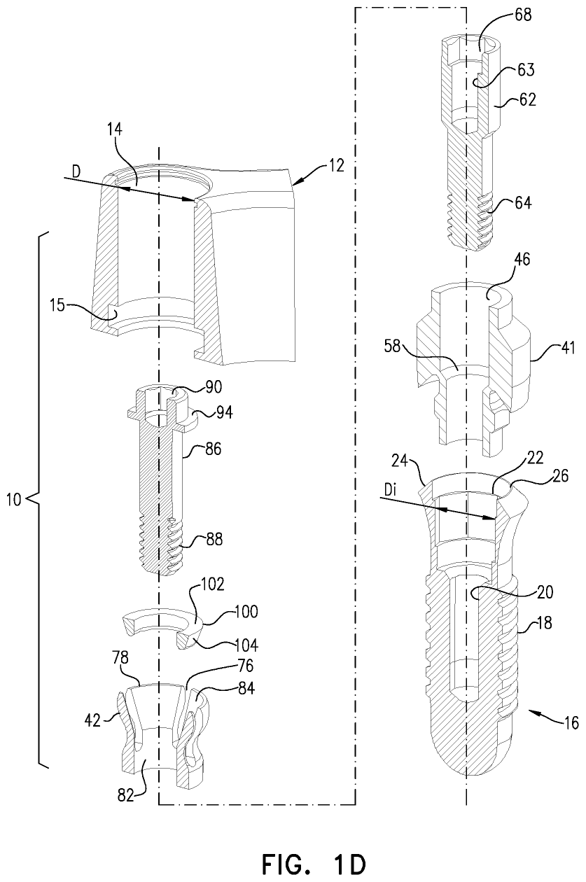

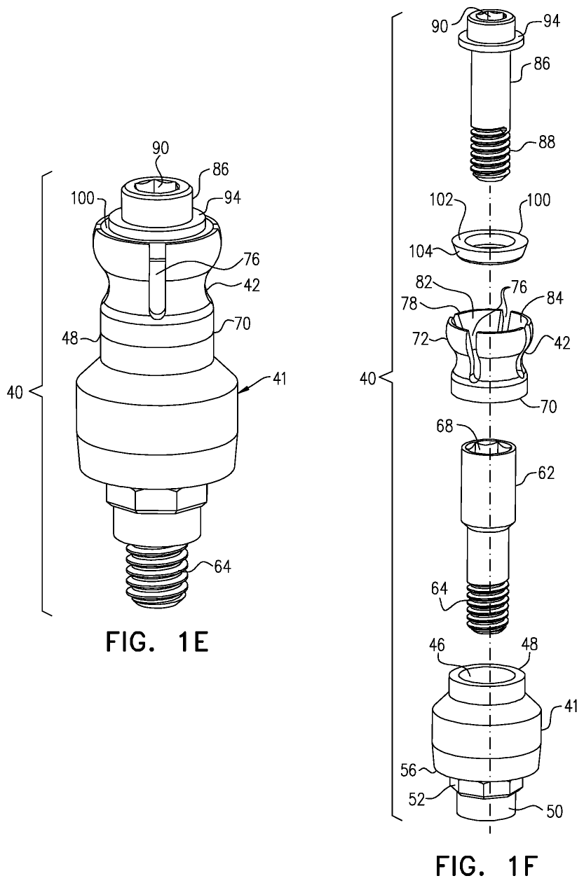

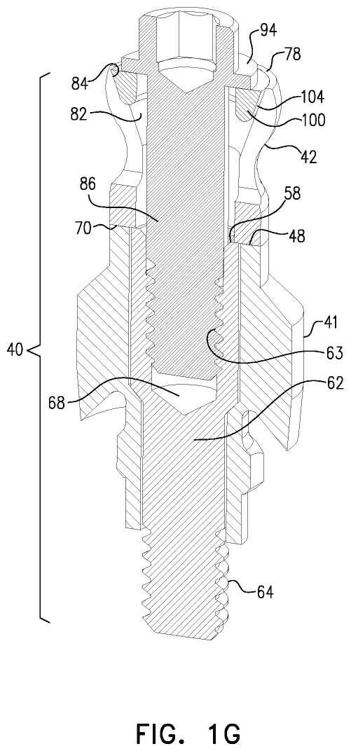

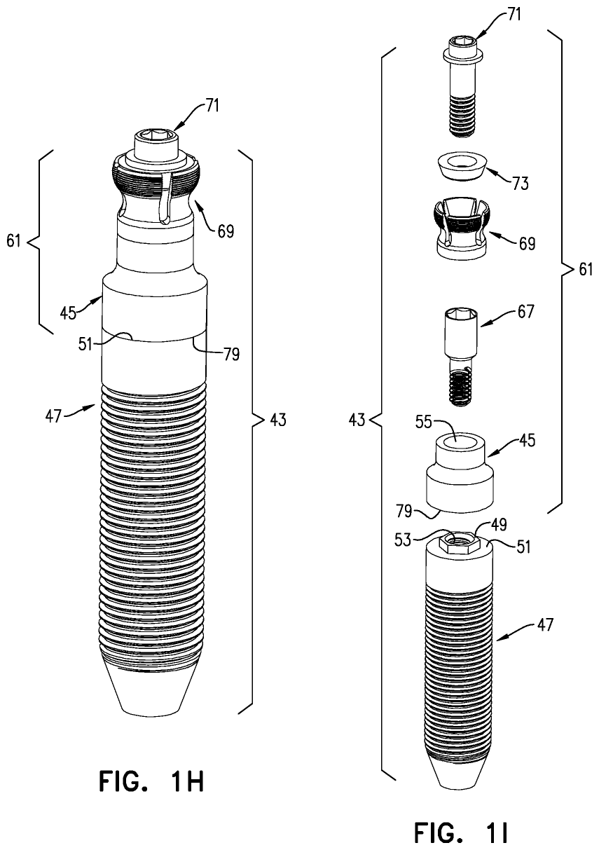

Attention is first directed to FIGS. 1A to 1G of the drawings, directed to a first embodiment of the disclosure. A dental set generally designated 10 comprises a schematically illustrated dental reconstruction element which in the illustrated example is part of a partial bridge 12. It is however appreciated that the dental reconstruction element can assume any form, any full or partial, of a support bar, mini support bar, full/partial denture, full or partial dental bridge, dental crown, or any other similar dental element constituting or supporting any type of dental prosthesis, either in full or partial.

The dental reconstruction element 12 is configured with a bore 14 having a nominal diameter D (FIGS. 1C and 1D) with an annular groove 15 at a bottom portion thereof, the purpose of which will become apparent herein after.

A dental implant 16, of known structure is provided, said dental implant 16 comprising an external threading 18 for fitting into a cavity of a jaw bone (not shown) of an individual and an internal threading 20 at an abutment receiving bore 22, having a nominal diameter Di configured at a top end of the dental implant, and further wherein the dental implant comprises a tapering top collar 24 with a smooth top edge 26. Also, the dental abutment is configured with a polygonal (hexagonal in the illustrated example) head socket for fastening the dental implant within the jaw bone.

An abutment assembly 40 according to a first embodiment of the disclosure is seen isolated in FIGS. 1E to 1G. The abutment assembly 40 comprises an abutment body 41 and a tubular reconstruction element support 42. The abutment body is tubular and is configured with a through-going abutment bore 46 extending between a top (proximal) flat support end 48, and a bottom (distal) end configured with a boss 50 having an external diameter corresponding with Di of the abutment receiving bore 22, and is further configured with polygonal shaped portion 52 and a downward facing skirt portion 56. The arrangement is such that the boss 50 is shaped and sized for snug receiving within the abutment receiving bore 22, with the skirt portion 56 resting over the tapering top collar 24 with abutting surfaces, thereby substantially eliminating movement between the elements.

The abutment bore 46 is further configured with an inside fastener shoulder 58 whereby the abutment body 41 can be couplable to the dental implant 16 by an implant fastener 62 configured with an external threaded portion 64 (corresponding with the internal threading 20 at the abutment receiving bore 22) and a polygonal fastening socket 68, whereby fastening the abutment body 41 with the dental implant 16 is sturdy and substantially motion-free. The implant fastener 62 is further configured at a top portion thereof with an internal thread 63.

The tubular reconstruction element support 42 has a distal (bottom) flat seat end 70 bearing flush against the flat support end 48 of the abutment body 41, and is configured with a proximal anchoring head portion 72 configured with four symmetrically disposed, axially extending, slots 76, extending open from a top edge 78 of the reconstruction element support 42. Whilst in the illustrated examples the slots are axially disposed, it is appreciated that the slots can be helically disposed about the longitudinal axis of the reconstruction element support 42, and likewise, the reconstruction element support 42 can be configured with one or more slots. The reconstruction element support 42 is further configured with an axially extending through-going head bore 82 and inside tapering top section 84. A manipulating fastener, namely bolt 86 has a threaded portion 88 corresponding with internal thread 63 of the implant fastener 62 and has a polygonal socket head 90 for fastening thereof, as well as a radially extending annular manipulating shoulder 94.

The abutment assembly further comprises a manipulating disc 100 configured with a top surface 102 and a tapering side wall 104. At assembly, the manipulating disc 100 is disposed within the tapering section 84 of the reconstruction element support 42, with the bottom face of the manipulating shoulder 94 of the manipulating fastener 86 bearing flush against the top surface 102. As a particular example, the top surface 102 of the manipulating disc 100 and the bottom face of the manipulating shoulder 94 are flat.

The arrangement is such that fastening the manipulating fastener 86 acts both to fasten the reconstruction element support 42 to the abutment body 41 (by coupling to implant fastener 62), and to apply axially directed force to the manipulating disc 100, which in turn gives rise to outwardly directed radial forces, aimed to the inside surface 84 of the reconstruction element support, causing the anchoring head (i.e. the segments) of the reconstruction element support 42 to expand and tighten against inside wall surface of bore 14 of the dental reconstruction element 12.

The arrangement disclosed hereinabove thus provides for compensating positioning tolerances and inaccuracies residing between axes of the dental implant 16 and the dental reconstruction element 12, where such tolerances can reside about a longitudinal axis (‘Z axis’) or about axes intersecting said longitudinal axis (‘X axis’ and ‘Y axis’). Such tolerances which may occur owing to measuring deviations, manufacturing deviations, etc. Such tolerances can extend axially, i.e. along the longitudinal axes of the dental system, or in planes intersecting said longitudinal axes.

It is noted that manipulating fastener 86 is finer than the implant fastener 62 and further that the reconstruction element support 42 can be made of the same material as that of the abutment body 41, or of a different material, with different mechanical properties. In addition, it is appreciated that the external surface of the anchoring head portion 72 of the reconstruction element support 42 can be smooth, as in the illustrated examples, or it can be surfaced for improved engagement with inside wall surface of the bore 14 of the dental reconstruction element 12. Such surfacing can be, for example, serrations, knurling, axial/annular ridges, axial/annular grooves, roughened surfacing, etc. Such configurations can be applied to any of the examples and embodiments disclosed herein.

Reverting to the assembled dental set 10, a sealing ring (not shown), e.g. a resilient O-ring, or a stainless steel ring, or any other material ring, can be fitted into the annular groove 15 within the bore 14 of the dental reconstruction element 12, such that at the assembled position the sealing ring is bears against an external surface of the abutment body 41, suitable to eliminate or substantially reduce saliva and food from entering into a space extending between the bore of the dental reconstruction element and the external surface of the abutment body. However, at times a sealing ring can be obviated.

Referring to FIGS. 1H to 1K there is illustrated a modification of the dental set 43 according to an aspect of the disclosure, wherein the significant difference resides in the shape of the abutment body 45 made suitable for mounting over a dental implant 47 which is configured with an external polygonal head.

The dental implant 47 is thus configured with an external polygonal head 49 projecting from a top surface 51 and configured with an internally threaded bore 53. In turn, the abutment body 45 is configured with a through-going abutment bore 55 with an inside fastener shoulder 57 above a head receiving space 59 and a bottom surface 79.

Other components of the dental set 43 are similar with those disclosed in connection with the example of FIGS. 1A to 1G, wherein the abutment assembly 61 further comprises an implant fastener 67 for coupling the abutment body 45 to the dental implant 47, through the abutment bore 55, a tubular reconstruction element support 69 (substantially identical with tubular reconstruction element support 42) and articulated to the abutment body 45 by a manipulating fastener bolt 71 via a manipulating disc 73.

At the assembled position (FIGS. 1H and 1J) abutment body 45 is fastened over the dental implant 47 with the bottom surface 79 baring flush against surface 51 and with the external polygonal head 49 of the dental implant 47 received within the head receiving space 59. After tightening the implant fastener 67, the reconstruction element support 69 is positioned over the abutment body 45 and once the dental reconstruction element (not shown) is placed thereover, the manipulating fastener bolt 71 is tightened, thereby setting the accurate, true position of the dental reconstruction element thereover.

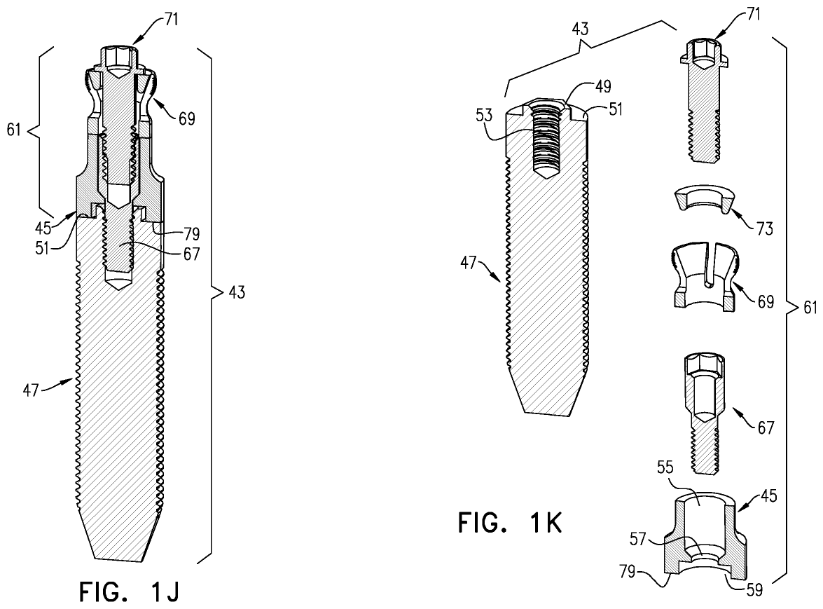

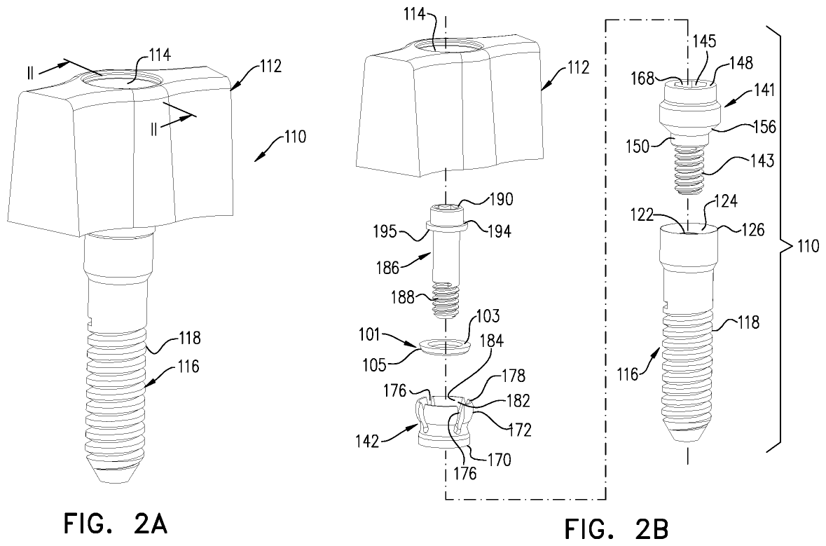

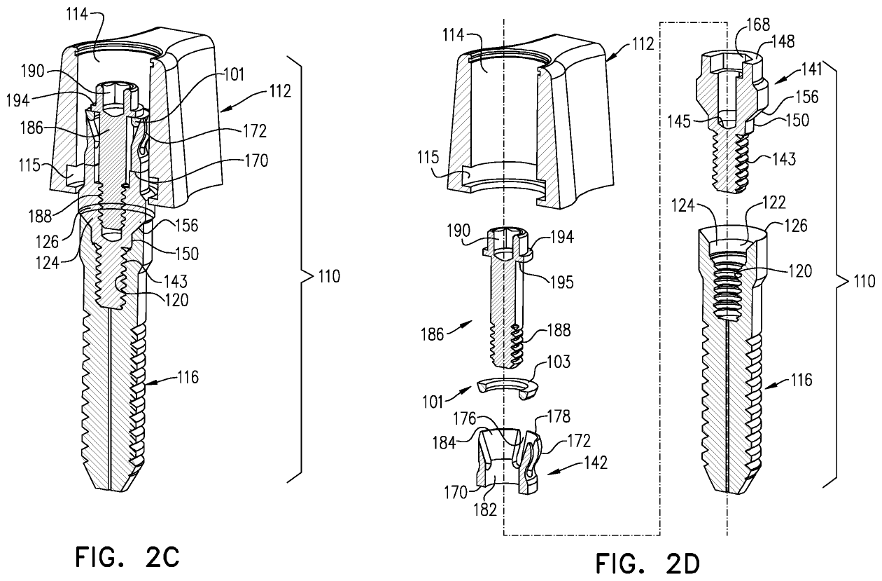

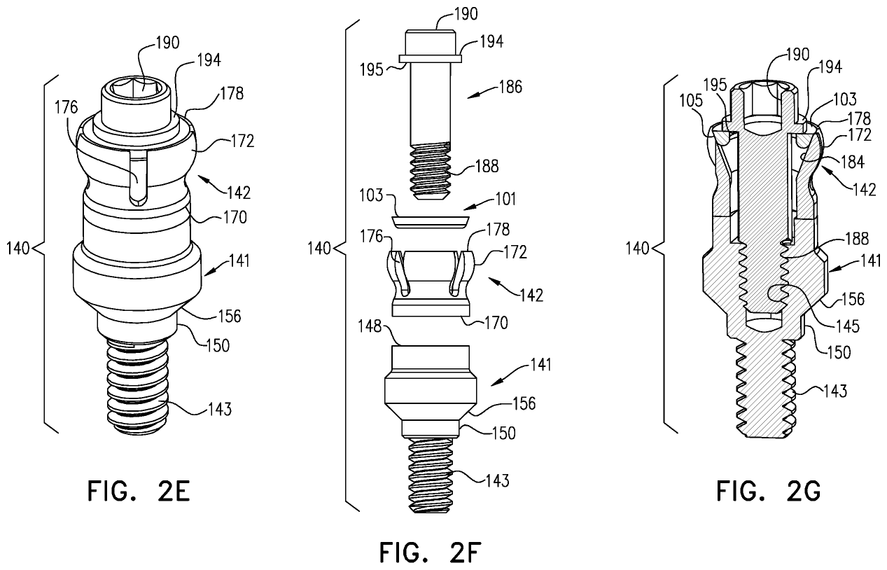

In the two embodiment of FIGS. 1A to 1K the abutment body 41; 45 is couplable to the dental implant by a separate implant fastener 62; 67. However, turning now to the embodiment illustrated in FIGS. 2A to 2G of the drawings, there is illustrated an example wherein the abutment body is couplable to the dental implant by an integral implant fastener. For sake of clarification, in the following example of FIGS. 2A to 2G, like elements as in FIGS. 1A to 1G are designated with like reference numbers, however shifted by 100.

The dental set of FIGS. 2 generally designated 110 comprises a schematically illustrated dental reconstruction element which in the illustrated example is part of a partial bridge 112.

The dental reconstruction element 112 is configured with a bore 114 having a nominal diameter D (FIGS. 2C and 2D) with an annular groove 115 at a bottom portion thereof, the purpose of which being similar to the disclosure in connection with the previous example.

A dental implant 116, of known structure is provided, said dental implant 116 comprising an external threading 118 for fitting into a cavity of a jaw bone (not shown) of an individual and an internal threading 120 at an abutment receiving bore 122, having a nominal diameter configured at a top end of the dental implant, and further wherein the dental implant comprises a tapering top collar 124 with a smooth top edge 126. The dental abutment is configured with a polygonal head socket for fastening the dental implant within the jaw bone.

An abutment assembly 140 according to the second embodiment of the disclosure is seen isolated in FIGS. 2E to 2G. The abutment assembly 140 comprises an abutment body 141 and a tubular reconstruction element support 142. The abutment body 141 is configured at a distal (bottom) end thereof with an integral, solid threaded stem 143 having an external nominal diameter corresponding with that the abutment receiving threaded bore 122. Further, the dental body 141 is configured at its top side with an internally threaded bore 145 and having and a polygonal fastening socket 168.

The implant body 141 has a top (proximal) flat support end 148, and a bottom (distal) end configured with a boss 150 having an external diameter corresponding with inside diameter of the abutment receiving bore 122, and is optionally configured with tapering portion 156. The arrangement is such that the boss 150 is shaped and sized for snug receiving within the abutment receiving bore 122, with the tapering portion 156 resting over the tapering top collar 124 with abutting surfaces, thereby substantially eliminating movement between the elements, once threaded stem 143 is fastened within the threaded receiving bore 122, whereby fastening the abutment body 141 with the dental implant 116 is sturdy and substantially motion-free.

The tubular reconstruction element support 142 has a distal (bottom) flat seat end 170 bearing flush against the flat support end 148 of the abutment body 141, and is configured with a proximal anchoring head portion 172 configured with four symmetrically disposed, axially extending, slots 176, extending open from a top edge 178 of the reconstruction element support 142. Whilst in the illustrated examples the slots are axially disposed, it is appreciated that the slots can be helically disposed about the longitudinal axis of the reconstruction element support 142, and likewise, the number of slots can vary.

The reconstruction element support 142 is further configured with an axially extending through-going head bore 182 and inside tapering top section 184. A manipulating fastener, namely bolt 186 has an external threaded portion 188 corresponding with internal thread 145 of the abutment body 141 and has a polygonal socket head 190 for fastening thereof, as well as a radially extending annular manipulating shoulder 194 having a bottom face 195.

The abutment assembly 140 further comprises a manipulating disc 101 configured with a top surface 103 and a tapering (bottom) side wall 105. At assembly, the manipulating disc 101 is disposed within the tapering section 184 of the reconstruction element support 142, with the bottom face 195 of the manipulating shoulder 194 of the manipulating fastener 186 bearing flush against the top surface 103. In this particular example too, the top surface of the manipulating disc and the bottom face of the manipulating shoulder are flat.

The arrangement is such that fastening the manipulating fastener 186 acts both to fasten the reconstruction element support 142 to the abutment body 141, and to apply axially directed force to the manipulating disc 101, which in turn gives rise to outwardly directed radial forces, aimed to the inside surface 184 of the reconstruction element support, causing the anchoring head (i.e. the segments) of the reconstruction element support 142 to expand and tighten against inside wall surface of bore 114 of the dental reconstruction element 112.

Similar to the previous example, the arrangement disclosed hereinabove thus provides for compensating positioning tolerances and inaccuracies residing between axes of the dental implant 116 and the dental reconstruction element 112, where such tolerances can reside about a longitudinal axis (‘Z axis’) or about axes intersecting said longitudinal axis (‘X axis’ and ‘Y axis’). Such tolerances which may occur owing to measuring deviations, manufacturing deviations, etc. Such tolerances can extend axially, i.e. along the longitudinal axes of the dental system, or in planes intersecting said longitudinal axes.

Likewise, it is appreciated that the external surface of the anchoring head portion 172 of the reconstruction element support 142 can be smooth, as in the illustrated examples, or it can be surfaced for improved engagement with inside wall surface of the bore 114 of the dental reconstruction element 112. Such surfacing can be, for example, serrations, knurling, axial/annular ridges, axial/annular grooves, roughened surfacing, etc.

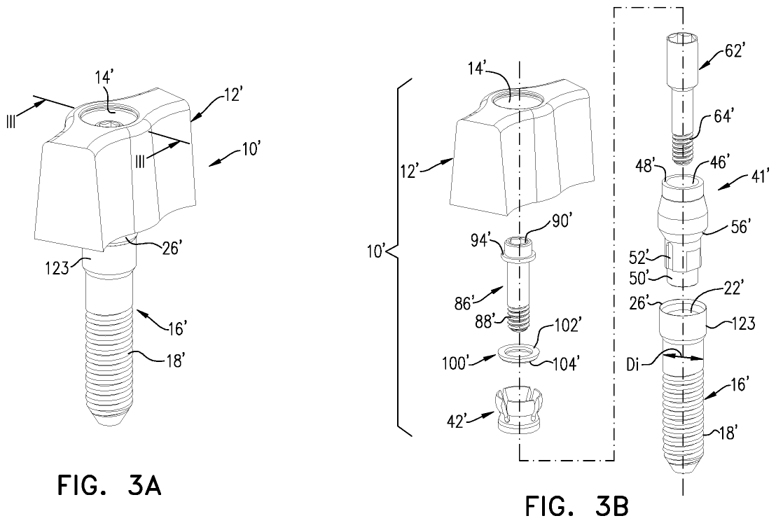

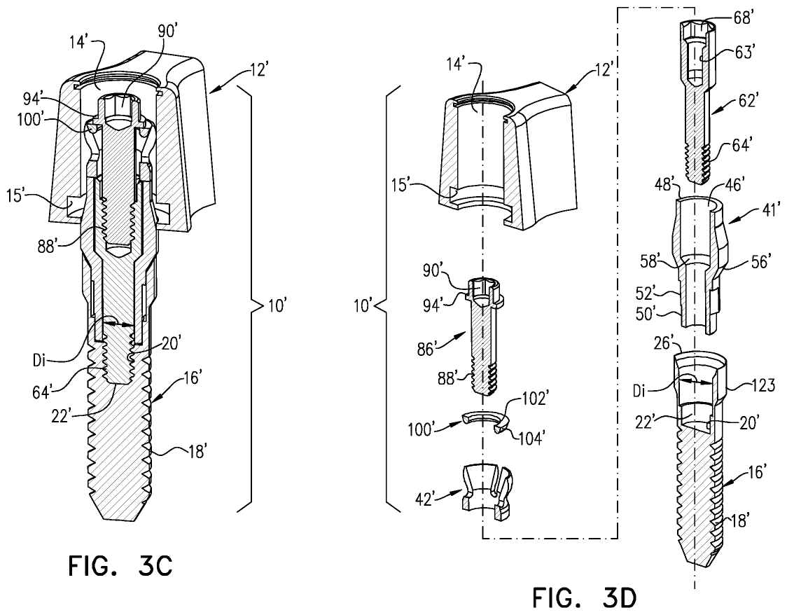

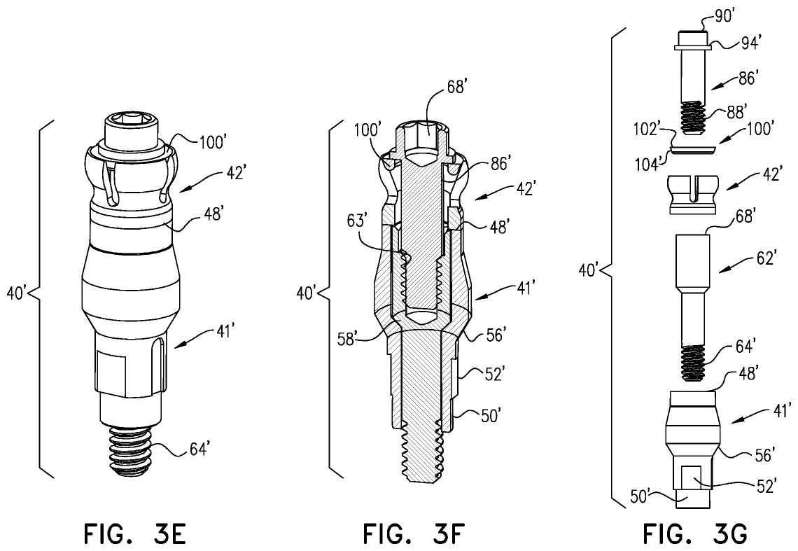

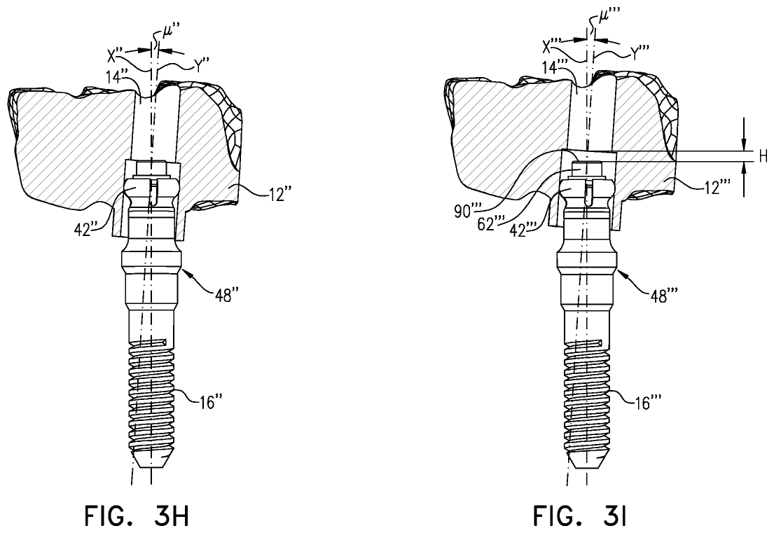

Further attention is now directed to FIGS. 3A to 3G directed to a modification of the first embodiment illustrated in FIGS. 1A to 1G. for sake of simplicity, like elements are designated with like reference numbers, with the addition of a ′ indicator.

In fact, the dental set 10′ is similar to that disclosed in the example of FIGS. 1A to 1G, however with different design concerning the abutment body 41′ and the dental implant 16′, respectively. Accordingly, reference in the following example is emphasized on the different elements.

The dental set 10′ thus comprises a schematically illustrated dental reconstruction element which in the illustrated example is part of a partial bridge 12′ configured with a 20 bore 14′ having a nominal diameter.

A dental implant 16′ comprising an external threading 18′ for fitting into a cavity of a jaw bone (not shown) of an individual and an internal threading 20′ having a nominal diameter Di at an abutment receiving bore 22′, configured at a top end of the dental implant, with a top head portion 123 with a smooth top edge 26′.

An abutment assembly 40′ comprises an abutment body 41′ and a tubular reconstruction element support 42′, the later being similar to reconstruction element support 42 of the example of Figs, 1A to 1G and reference is made back thereto.

The abutment body 41′ is tubular and is configured with a through-going abutment bore 46′ extending between a top (proximal) flat support end 48′, and a bottom (distal) end configured with a boss 50′ having an external diameter corresponding with Di of the abutment receiving bore 22′, and is further configured with a gripping portion 52′ and a tapering portion 56′ configured for snug and fit receipt within the abutment receiving bore 22′ of the dental implant 16′ . The arrangement is such that the boss 50′ is shaped and sized for snug receiving within the abutment receiving bore 22′, with the tapering portion 56′ abutting surfaces of the bore 22′, thereby substantially eliminating movement between the elements.

The abutment bore 46′ of the abutment body 41′ is further configured with an inside fastener shoulder 58′ whereby the abutment body 41′ can be couplable to the dental implant 16′ by an implant fastener 62′ configured with an external threaded portion 64′ (corresponding with the internal threading 20′ at the abutment receiving bore 22′) and a polygonal fastening socket 68′, whereby fastening the abutment body 41′ with the dental 10 implant 16′ is sturdy and substantially motion-free. The implant fastener 62′ is further configured at a top portion thereof with an internal thread 63′.

A manipulating fastener, namely bolt 86′ has a threaded portion 88′ corresponding with internal thread 63′ of the implant fastener 62′ and has a polygonal socket head 90′ for fastening thereof, as well as a radially extending annular manipulating shoulder 94′.

The abutment assembly further comprises a manipulating disc 100′ configured with a top surface 102′ and a tapering side wall 104′. At assembly, the manipulating disc 100′ is disposed within the tapering section 84′ of the reconstruction element support 42′, with the bottom face of the manipulating shoulder 94′ of the manipulating fastener 86′ bearing flush against the top surface 102′.

The arrangement is such that fastening the manipulating fastener 86′ acts both to fasten the reconstruction element support 42′ to the abutment body 41′ (by coupling to implant fastener 62′), and to apply axially directed force to the manipulating disc 100′, which in turn gives rise to outwardly directed radial forces, aimed to the inside surface 84′ of the reconstruction element support, causing the anchoring head (i.e. the segments) of the reconstruction element support 42′ to expand and tighten against inside wall surface of bore 14′ of the dental reconstruction element 12′.

The arrangement disclosed hereinabove thus provides for compensating positioning tolerances and inaccuracies residing between axes of the dental implant 16 and the dental reconstruction element 12′, where such tolerances can reside about a longitudinal axis (‘Z axis’) or about axes intersecting said longitudinal axis (‘X axis’ and ‘Y axis’). Such tolerances which may occur owing to measuring deviations, manufacturing deviations, etc. Such tolerances can extend axially, i.e. along the longitudinal axes of the dental system, or in planes intersecting said longitudinal axes.

In addition, it is appreciated that the external surface of the anchoring head portion 72′ of the reconstruction element support 42′ can be smooth, as in the illustrated examples, or it can be surfaced for improved engagement with inside wall surface of the bore 14′ of the dental reconstruction element 12′. Such surfacing can be, for example, serrations, knurling, axial/annular ridges, axial/annular grooves, roughened surfacing, etc. Such configurations can be applied to any of the examples and embodiments disclosed herein.

Likewise, a sealing ring (not shown) can be into annular groove 15′ of the dental reconstruction element 12, such that at the assembled position the sealing ring is bears against an external surface of the abutment body 41′, suitable to eliminate or substantially reduce saliva and food from entering into a space extending between the bore of the dental reconstruction element and the external surface of the abutment body.

In FIG. 3H there is illustrated a dental set as per the example of FIGS. 3A to 3G, wherein the dental implant 16″ and the associated abutment body 48″ and the reconstruction element support 42″ extend along a longitudinal axis X″, whilst the dental reconstruction element 12″ is disposed at an angle Y″ thereabout, with an angle μ″ therebetween, and however is set in place by the reconstruction element support 42″ as discussed above.

Yet an example of rectifying tolerance issues is exemplified in FIG. 3I, demonstrating a dental set as per the example of FIGS. 3A to 3G, wherein the dental implant 16′″ and the associated abutment body 48′″ and the reconstruction element support 42′″ extend along a longitudinal axis X′″, whilst the dental reconstruction element 12′″ is disposed at an angle Y′″ thereabout, with an angle μ′″ therebetween, and further wherein the dental reconstruction element 12′″ is spaced at a distance H from the top end of polygonal socket head 90′″ of the implant fastener 62′″, and however is set in place by the reconstruction element support 42″ as discussed above.

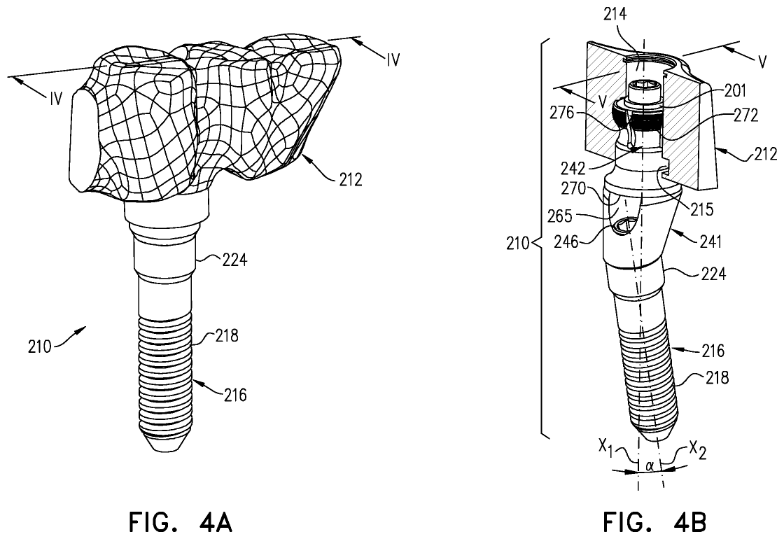

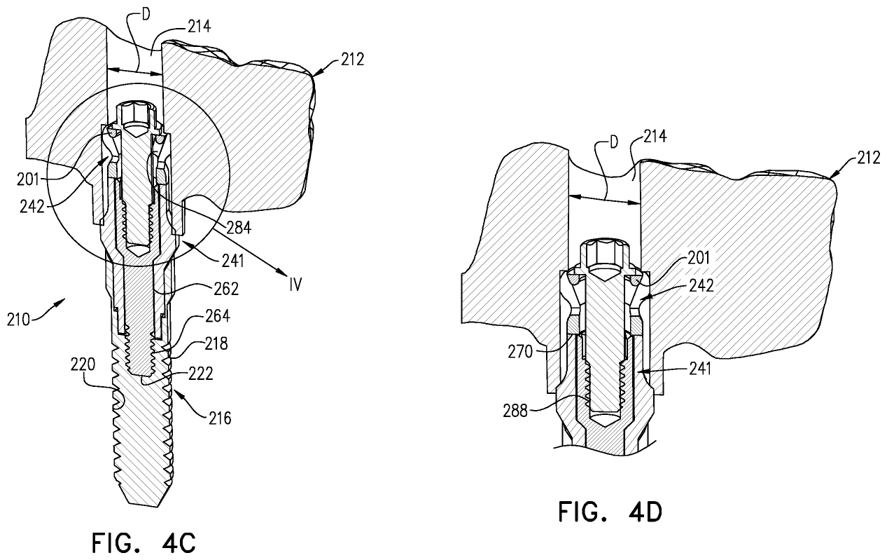

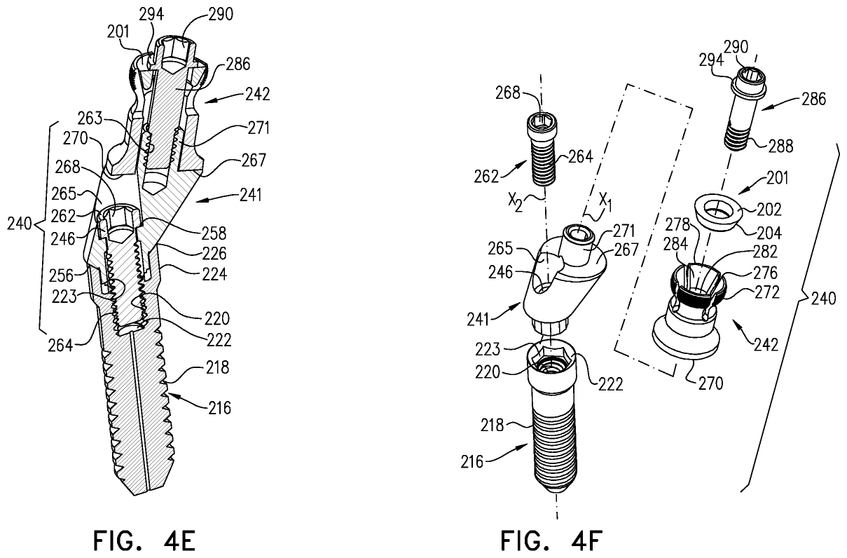

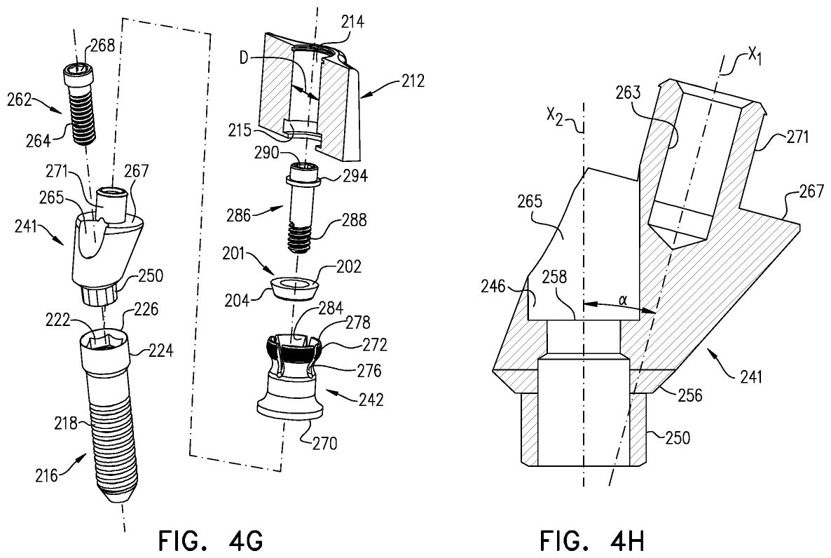

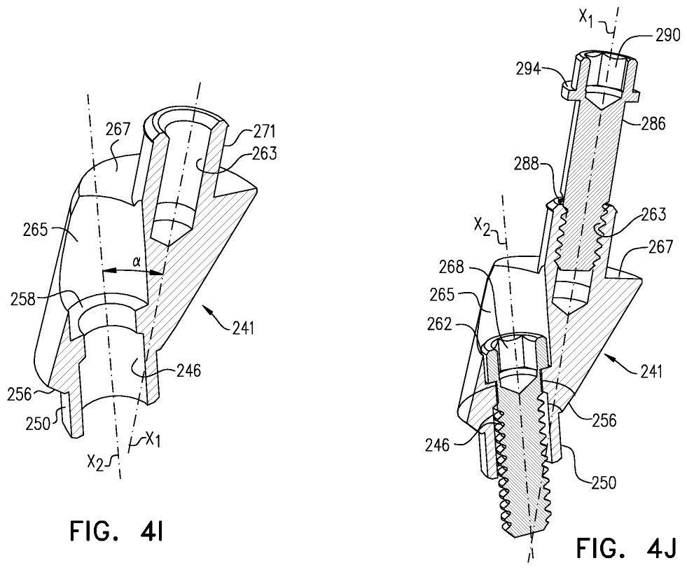

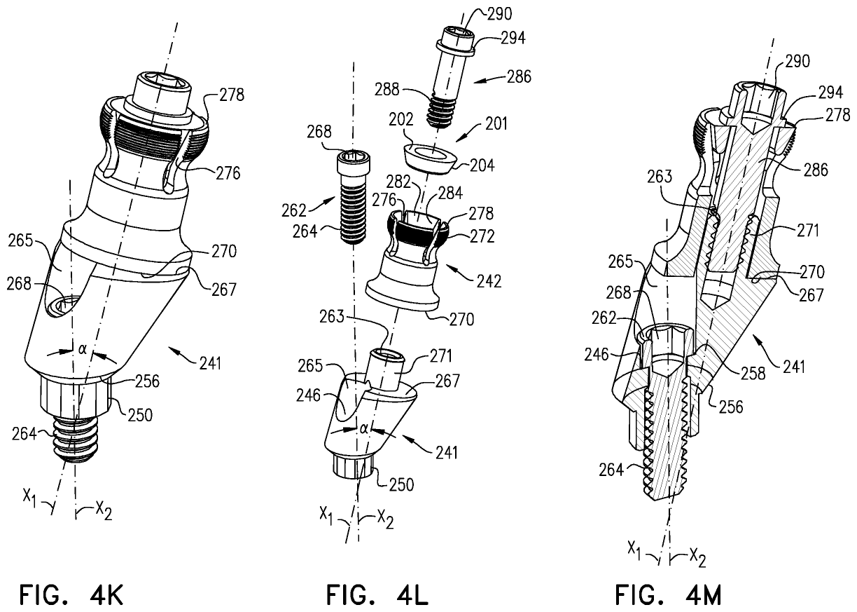

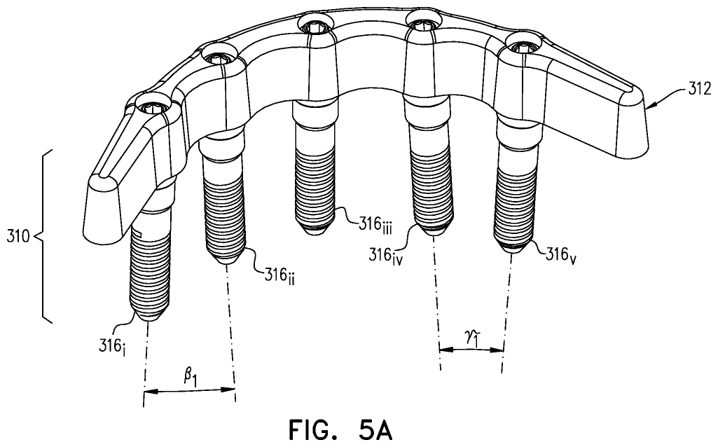

Yet another embodiment is disclosed in FIGS. 4A to 4L directed to an adjustable dental set generally designated 210 ,and wherein for sake of clarification, in the following example like elements as in FIGS. 1A to 1G are designated with like reference numbers, however shifted by 200.

The dental set 210 comprises a dental reconstruction element which in the illustrated example is part of a partial bridge 212. It is however appreciated that the dental reconstruction element can assume any form, any full or partial, of a support bar, mini support bar, full/partial denture, full or partial dental bridge, dental crown, or any other similar dental element constituting or supporting any type of dental prosthesis, either in full or partial.

The dental reconstruction element 212 is configured with a bore 214 having a nominal diameter D with an annular groove 215 at a bottom portion thereof, the purpose of which will become apparent herein after.

A dental implant 216, of known structure is provided, said dental implant 216 comprising an external threading 218 for fitting into a cavity of a jaw bone (not shown) of an individual and an internal threading 220 at an abutment receiving bore 222, having a nominal diameter, and further wherein the dental implant comprises a tapering top collar 224 with a smooth top edge 226, and a polygonal head socket 223 for fastening the dental implant 216 within the jaw bone.

An abutment assembly 240 according to a different embodiment of the disclosure is seen isolated in FIGS. 4E and 4F. The abutment assembly 240 comprises an abutment body 241 and a tubular reconstruction element support 242. The abutment body 241 is generally a tubular configured with a longitudinal second axis X2 configured with a through-going abutment bore 246 configured with at a distal (bottom) end with a polygonal boss 250, said polygonal boss configured for receiving within the polygonal head socket 223 of the dental abutment 216, at discrete angular increments, depending of course on the number of faces of the polygonal socket 223 and the number of faces of the a polygonal boss 250.

According to a particular example the external polygonal boss 250 of the abutment body 241 is a 12 faced polygon and the polygonal socket 223 of the dental implant 216 is a 6 faced polygon, imparting the abutment body axial angular increments of 30° over the dental implant. However, other combinations of polygonal boss and polygonal socket can be adopted, e.g. an 8 faced polygonal boss with an 8 faced polygonal socket, 8 faced polygonal boss with a 16 faced polygonal socket, a 6 faced polygonal boss with a 6 faced polygonal socket, etc.

The abutment body 241 is further configured with a tapering portion facing skirt portion 256 such that the boss 250 is shaped and sized for snug receiving within the abutment receiving bore 222, with the skirt portion 256 resting within a corresponding tapering portion within the top collar 224 of the dental implant 216, thereby substantially eliminating movement between the elements once coupled.

The abutment bore 246 is further configured with an inside fastener shoulder 258 whereby the abutment body 241 can be couplable to the dental implant 216 by an implant fastener 262 configured with an external threaded portion 264 (corresponding with the internal threading 220 at the abutment receiving bore 222) and a polygonal fastening socket 268, whereby fastening the abutment body 241 with the dental implant 216 is sturdy and substantially motion-free. The implant fastener 262 is accessible for fastening through an opening 265 configured at a flat top surface of the abutment body 241, whereby the abutment body 241 are coupled to one another about the longitudinal second axis X2.

The abutment body 241 is further configured with a tubular boss 271 upwardly projecting from the flat surface 267 and extending along a first axis X1, said tubular boss 271 configured with an internal thread 263, and wherein according to the particular illustrated example said first axis X1 and said second axis X2 intersect each other about an imaginary plane, wherein the angle α between the first axis and the second axis is in the range of about 3° to 8°, and typically about 5°.

The tubular reconstruction element support 242 has a distal (bottom) flat seat end 70 which at an assembled position bears flush against the flat surface 267 of the abutment body 241, and is configured with a proximal anchoring head portion 272 configured with four symmetrically disposed, axially extending, slots 276, extending open from a top edge 278 of the reconstruction element support 242. Whilst in the illustrated examples the slots are axially disposed, it is appreciated that the slots can be helically disposed about the longitudinal axis of the reconstruction element support 242, and likewise, the number of slots can vary.

The reconstruction element support 42 is further configured with an axially extending through-going head bore 282 and inside tapering top section 284. A manipulating fastener, namely bolt 286 has a threaded portion 288 corresponding with internal thread 263 of the implant fastener 262 and has a polygonal socket head 290 for fastening thereof, as well as a radially extending annular manipulating shoulder 294.

The abutment assembly 240 further comprises a manipulating disc 201 configured with a flat top surface 202 and a tapering side wall 204. At assembly, the manipulating disc 201 is disposed within the tapering section 284 of the reconstruction element support 242, with the bottom face of the manipulating shoulder 294 of the manipulating fastener 286 bearing flush against the flat top surface 202.

The arrangement is such that fastening the manipulating fastener 286 acts both to fasten the reconstruction element support 242 to the abutment body 241 (by coupling to implant fastener 262), and to apply axially directed force to the manipulating disc 201, which in turn gives rise to outwardly directed radial forces, aimed to the inside surface 284 of the reconstruction element support, causing the anchoring head (i.e. the segments) of the reconstruction element support 242 to expand and tighten against inside wall surface of bore 214 of the dental reconstruction element 212.

The arrangement disclosed hereinabove thus provides for compensating positioning tolerances and inaccuracies residing between axes of the dental implant 216 and the dental reconstruction element 212, where such tolerances can reside about a longitudinal axis (‘Z axis’) or about axes intersecting said longitudinal axis (‘X axis’ and ‘Y axis’). Such tolerances which may occur owing to measuring deviations, manufacturing deviations, etc. Such tolerances can extend axially, i.e. along the longitudinal axes of the dental system, or in planes intersecting said longitudinal axes.

The angular deviation a between the first axis X1 and the second axis X2, together with the discrete, incremental angular positioning of the abutment assembly 240 with respect to the longitudinal axis of the dental abutment 216 offers a unique configuration providing support of a dental reconstruction element at a variety of setups, regardless of the preset axial alignment of the dental implant, yet at a sturdy manner and further with the ability to overcome three dimensional tolerances.

In addition, it is appreciated that the external surface of the anchoring head portion 272 of the reconstruction element support 242 is surfaced for improved engagement with inside wall surface of the bore 14 of the dental reconstruction element 12. Such surfacing in the present example, comprises annular ridges. Though it can be, for example, serrations, knurling, axial/annular ridges, axial/annular grooves, roughened surfacing, etc.

Reverting to the assembled dental set 210, a sealing ring (not shown), e.g. a resilient O-ring, or a metal ring, can be fitted into the annular groove 215 within the bore 214 of the dental reconstruction element 212, such that at the assembled position the sealing ring is bears against an external surface of the abutment body 241, suitable to eliminate or substantially reduce saliva and food from entering into a space extending between the bore of the dental reconstruction element and the external surface of the abutment body.

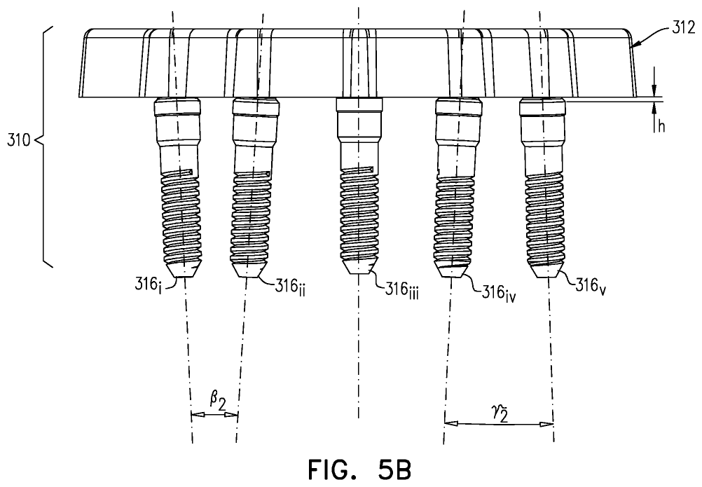

FIGS. 5A and 5B of the drawings illustrate a dental set 310 comprising a dental reconstruction element being a support bar 312 mounted over 5 dental implants 316ᵢ to 316ᵥ. It is noted that at least some of the dental implants 316ᵢ to 316ᵥ are not parallelly disposed, at times in more than one axis. For example, dental implant 316ᵢ is angularly offset at angles β₁ and β₂ with respect to dental implant 316ᵢᵢ, and dental implant 316iv is angularly offset at angles γ₁ and γ₂with respect to dental implant 316ᵥ. Such angular disorders, as well as tolerances and inaccuracies residing between axes of the dental implants 316ᵢ to 316ᵥ and the dental reconstruction element 312 e.g. axial (elevation) gap h (FIG. 5B) can be overcome by dental abutments according to any of the herein disclosed embodiments, (such tolerances and inaccuracies may occur owing to measuring deviations, manufacturing deviations, etc.).

1. A dental abutment comprising a cylindrical abutment body and a tubular reconstruction element support; the abutment body is couplable to a dental implant and comprises a flat support end, the reconstruction element support has a proximal anchoring head portion configured with at least one slot, and a distal seat end bearing flush against the flat support end of the abutment body, said reconstruction element support is further configured with an axially extending through-going head bore, whereby the reconstruction element support is coupled to the abutment body by a manipulating fastener extending through the bore, and wherein axial fastening the fastener entails radial expansion of the anchoring head.

2. A dental abutment according to claim 1, wherein the abutment body is tubular and is configured with a through-going abutment bore extending between an implant end and the flat support end, said abutment bore configured with an inside fastener shoulder, whereby the abutment body is couplable to a dental implant by a implant fastener extending through the abutment body.

3. A dental abutment according to claim 1, wherein the manipulating fastener is screw coupled within an internal threading configured within the implant fastener.

4. A dental abutment according to claim 1, wherein the abutment body is a tubular body configured at an implant end thereof with an integral threaded fastener couplable within a threaded bore of a dental implant, said abutment body is further configured at an opposite end thereof with a wrench engaging portion.

5. A dental abutment according to claim 1, wherein the manipulating fastener is screw coupled within an internal threading configured within the abutment body.

6. A dental abutment according to claim 1, wherein the at least one slot of the reconstruction element support extends form the proximal towards the seat end.

7. A dental abutment according to claim 1, wherein the abutment body is configured with a first axis and a second axis; with a threaded bore extending along said first axis for screw coupling the tubular reconstruction element support, and wherein the abutment body is couplable to a dental implant along said second axis.

8. A dental abutment according to claim 7, wherein the first axis and the second axis intersect each other about an imaginary plane.

9. A dental abutment according to claim 7, wherein the abutment body is configured with an implant end configured for bearing over an internal head portion of a dental implant, said implant end is configured as an external polygonal boss couplable at discrete angular increments within a polygonal socket of the dental implant, said polygonal boss coextends along said second axis.

10. A dental abutment according to claim 1, wherein the abutment body is couplable to a dental implant directly or indirectly, with an intermediate adapter seat member disposed therebetween, wherein the adapter seat member has a body with a thorough going bore extending between abutment end mimicking an external head portion of a dental implant, and an implant end configured for bearing over an internal head portion of a dental implant.

11. A dental abutment according to claim 10, wherein the adapter seat member is integral with or integrated with the abutment body.

12. A dental abutment according to claim 1, wherein a dental implant end of the abutment body is configured for direct bearing over an external cylindrical head portion of a dental implant, or over an adapter seat member extending between the abutment body and the dental implant.

13. A dental abutment according to claim 1, wherein a dental implant end of the abutment body is cylindrical and is configured for at least partially insertion into an open end of a dental implant.

14. A dental abutment according to claim 1, wherein a portion od the abutment body is configured at an external face thereof with a wrench gripping arrangement.

15. A dental abutment according to claim 1, wherein the at least one slot of the of the reconstruction element support extends axially, parallel to an axis of the longitudinal head bore, imparting it a symmetrically segmented shape.

16. A dental abutment according to claim 15, wherein the at least one slot of the of the reconstruction element support extends helically about the longitudinal axis of the reconstruction element support.

17. A dental abutment according to claim 1, wherein the anchoring head of the reconstruction element support is configured with symmetrically disposed at least two slots.

18. A dental abutment according to claim 1, wherein the anchoring head portion of the reconstruction element support is configured with a cylindrical external cross-section.

19. A dental abutment according to claim 1, wherein the anchoring head portion of the reconstruction element support is configured with a externally spherical or has a spherical portion, or a rounded portion cross-section.

20. A dental abutment according to claim 1, wherein at least the anchoring head portion of the reconstruction element support is configured with surfacing for improved engagement with inside wall surface of the bore of a dental reconstruction element.

21. A dental abutment according to claim 1, wherein a distal end of the axially extending through-going head bore of the reconstruction element support is configured with an inwardly tapering section, configured for engagement with a radial annular projection of the manipulating fastener.

22. A dental abutment according to claim 1, wherein a distal end of the axially extending through-going head bore of the reconstruction element support is configured with an inwardly tapering section, configured for engagement with a radial annular projection of the manipulating fastener.

23. A dental abutment according to claim 1, wherein the radial annular projection of the manipulating fastener is cylindrical.

24. A dental abutment according to claim 1, wherein the radial annular projection of the manipulating fastener is tapering in direction of tapering section of the reconstruction element support.

25. A dental abutment according to claim 1, wherein at an assembled position, the tubular reconstruction element support extends coaxially with abutment body.

26. A dental abutment according to claim 1, wherein at an assembled position, the manipulating fastener extends coaxially with the tubular reconstruction element support.

27. A dental abutment according to claim 1, wherein a distal portion of the abutment body is configured with a tapering shoulder, which upon coupling to a dental implant bears over a correspondingly tapering internal tapering portion of the dental implant.

28. A dental abutment according to claim 1, wherein the bore of a dental reconstruction element is configured at a distal end thereof with an annular shoulder, which at an assembled position is configured for bearing over a cylindrical portion of the abutment body.

29. A dental abutment according to claim 1, wherein a resilient sealing member is disposed between a distal end of the bore of a dental reconstruction element mountable thereover, and an external surface of the abutment body.

30. A dental reconstruction element comprising a thorough going bore configured for snug receiving at least a reconstruction element support of a dental abutment, said thorough going bore further configured for bearing radial engaging forces applied thereto by an anchoring head of the reconstruction element support which in turn is articulated to the dental abutment.

31. A dental reconstruction set comprising one or more of each of a dental reconstruction element, a dental implant, and a dental abutment comprising a dental abutment comprising a cylindrical abutment body and a tubular reconstruction element support; the abutment body is couplable to a dental implant and comprises a flat support end, the reconstruction element support has a proximal anchoring head portion configured with at least one slot, and a distal seat end bearing flush against the flat support end of the abutment body, said reconstruction element support is further configured with an axially extending through-going head bore, whereby the reconstruction element support is coupled to the abutment body by a manipulating fastener extending through the bore, and wherein axial fastening the fastener entails radial expansion of the anchoring head.
